(19) United States
(12) Patent Application Publication
(10) Pub. No.: US 2005/0280264 A1
(43) Pub. Date: Dec. 22, 2005

(54) Multistage wind-powered generator with shafts and a coupling system

(76) Inventor: Sandor Nagy, Hochheim (DE)

Correspondence Address: HARNESS, DICKEY & PIERCE, P.L.C., P.O.BOX 8910, RESTON, VA, 20195, US

(21) Appl. No.: 10/438,976

(22) Filed: May 16, 2003

(30) Foreign Application Priority Data
May 18, 2002 (DE) DE 10222179.0
Jul. 24, 2002 (DE) DE 10233589.3

(51) Int. Cl. F03D 9/00; H02P 9/04

(52) U.S. Cl. 290/55

(57) ABSTRACT

A wind-powered generator can be used with high efficiency, not only in large wind-powered systems but also in smaller versions. Two or more generators are arranged, either one behind the other or side by side, after a mechanical device which uses wind power. The two or more generators which are connected to one another by widely differing types of coupling systems.

The present application hereby claims priority under 35 U.S.C. §119 on German patent application numbers DE 10222179.0 filed May 18, 2002, and DE 10233589.3 filed Jul. 24, 2002, the entire contents of each of which are hereby incorporated herein by reference.

### FIELD OF THE INVENTION

The invention generally relates to a multistage wind-powered generator. Preferably, it relates to one including two or more generators which are arranged one behind the other or alongside one another and are connected to one another by widely differing types of coupling systems.

Additionally, the invention preferably may relate to a multistage wind-powered generator, in which two or more generators (at least two) are arranged one behind the other and are connected to one another by means of shafts and coupling systems.

### BACKGROUND OF THE INVENTION

Present-day wind-powered generators include a wind-powered rotor and a generator connected by way of a shaft.

### SUMMARY OF THE INVENTION

In contrast, in the case of the multistage wind-powered generator according to an embodiment of the invention, two or more generators (at least two) are connected to one another by way of shafts and coupling systems, with the shafts and couplings being designed such that they connect or disconnect the individual generators successively, in a specific sequence. One generator (generator 1) always rotates with the wind-powered rotor but, as the rotation speeds rise, the generator 2 is added to the generator 1. Further, if the rotation speed rises further, the generator 3 is added, and possibly further generators are added. When the rotation speeds fall, they are decoupled in the opposite sequence, that is to say the generator which was the last to be connected being disconnected first, that is to say the generator 3; then the generator 2 is disconnected as the rotation speeds fall further.

In constant wind strengths, the generators also run in a constant manner, irrespective of the particular coupling constellation of the generators.

The power can be transmitted from the main shaft 4 to the generators 1, 2, 3, or to further generators as well, by way of a series configuration (one behind the other as shown in FIG. 1) or by way of a parallel or side-by-side configuration (illustrated in FIG. 3), or else by a combination of both options (illustrated in FIG. 2).

The most widely differing types of coupling systems may be used, such as widely differing types of centrifugal force couplings or widely differing types of hydraulic couplings (torque converters). Couplings can be designed such that they can be connected or disconnected by remote control.

The multistage wind-powered generator can make use of a wider range of wind strengths for generating electricity. It can be used not only in large wind-powered systems, but also in smaller versions for generating electricity for domestic systems, recreational vehicles, for camping, for boats, for ships or for other fields in which wind power is used for electricity generation. Depending on the form of use and the type, the size of the individual generators as well as their size ratios are variable with respect to one another.

### BRIEF DESCRIPTION OF THE DRAWINGS

The invention is explained in more detail below using exemplary embodiments with reference to the drawings, in which:

FIG. 1 shows a multistage wind-powered generator with generators 1, 2, 3 coupled to one another one behind the other, in series;

FIG. 2 shows a combination of the series and parallel configuration of the multistage wind-powered generator;

FIG. 3 shows all the generators arranged in parallel or alongside one another with respect to the main shaft 4;

FIG. 4 shows a multistage wind-powered generator with a series configuration, with the wind-powered rotor 7 being mounted on the generator shaft of the first generator stage 1, between the generators 1 and 2;

FIG. 5 shows a different type of wind-powered rotor, and illustrates that the multistage wind-powered generator with shafts and coupling systems can be used in conjunction with all types of wind-powered rotors;

FIG. 6 shows a multistage wind-powered generator in which an epicyclic transmission 10 is arranged between the wind-powered rotor 7 and the first generator stage 1; and

FIG. 7 shows a wind-powered rotor with a multistage generator, with a transmission being arranged between the wind-powered rotor 7 and the first generator stage 1.

### DETAILED DESCRIPTION OF THE PREFERRED EMBODIMENTS

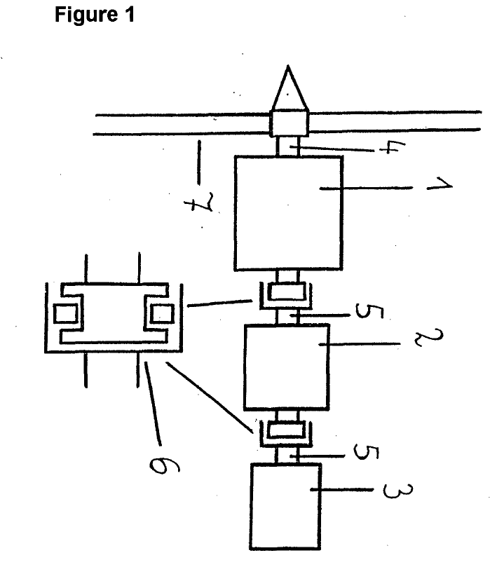

FIG. 1 shows a multistage wind-powered generator with generators 1, 2, 3 coupled to one another one behind the other, in series. The generators have continuous generator shafts, which are connected to one another by way of appropriate couplings. Each generator 1, 2, 3 has its own coupling system and shaft system.

The generator 2 and the generator 3 are connected in addition to the generator 1 or disconnected again as the wind speeds vary, and as the rotational speeds which result from these wind speeds vary.

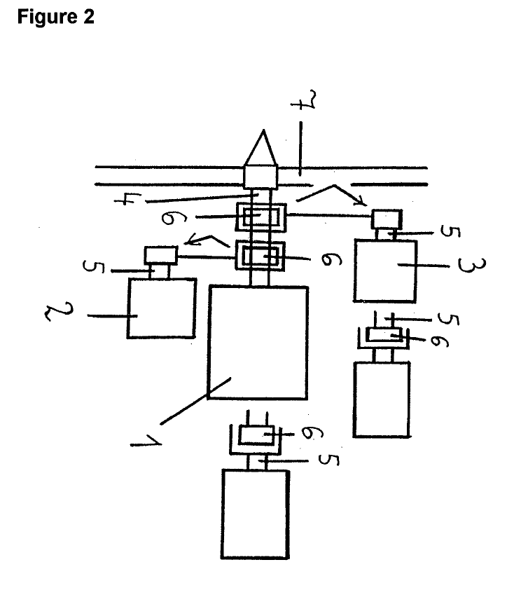

FIG. 2 shows a combination of the series and parallel configuration of the multistage wind-powered generator. The main generator 1 is connected directly to the main shaft 4. The generators 2 and 3 are connected by couplings 6 to the main shaft 4, and are arranged side by side.

The main generator 1 rotates, preferably always, with the main shaft 4. The generators 2 and 3 are connected successively as the rotation speeds rise. The couplings of the generators 2 and 3 may be arranged on the generator shaft or on the main shaft 4 and connect the generators 2 and 3, and disconnect them again, automatically as the rotation speeds vary.

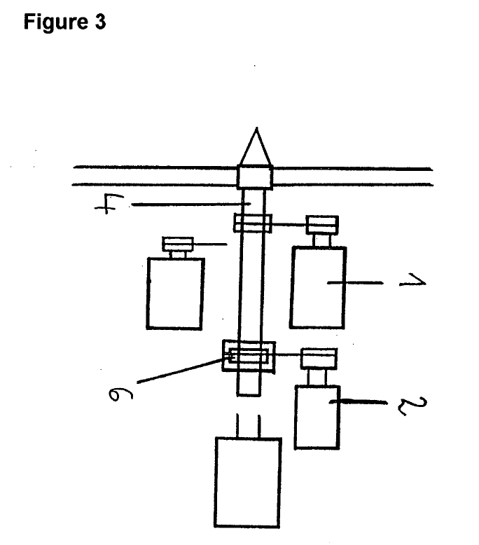

FIG. 3 shows all the generators arranged in parallel or alongside one another with respect to the main shaft 4. These generators are connected by couplings 6 to the main shaft 4. further, the coupling 6 may be arranged either on the main shaft 4 or on the generator shaft.

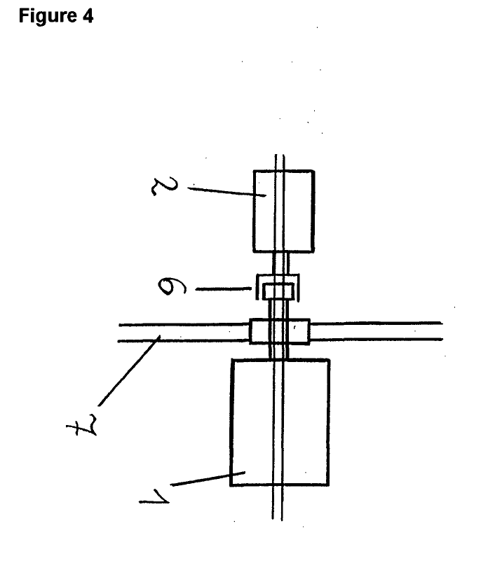

FIG. 4 shows a multistage wind-powered generator with a series configuration. The wind-powered rotor 7 is mounted on the generator shaft of the first generator stage 1, between the generators 1 and 2.

The shafts of the generators 1 and 2 are connected to one another by way of the coupling 6. As the rotation speeds rise and fall, the generator 2 is connected or disconnected by way of the coupling 6. With this configuration, a special type of holder or a continuous stationary shaft is required for the first and second generator stages. The generator stages can be held together by widely differing types of structure. Irrespective of the nature of the structure for holding them, the method of operation of the multistage wind-powered generator does not change, however.

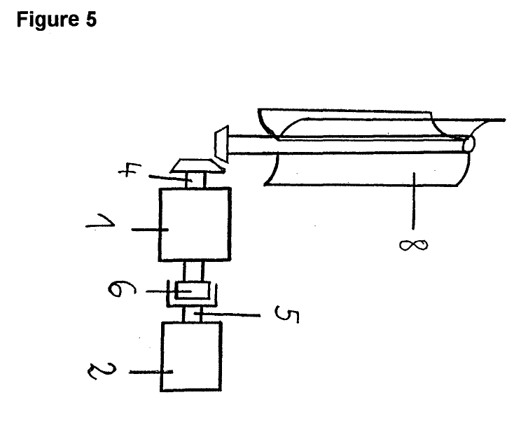

FIG. 5 shows a different type of wind-powered rotor, and illustrates that the multistage wind-powered generator with shafts and coupling systems can be used in conjunction with all types of wind-powered rotors. The configuration of the respective wind-powered rotor as well as the types of coupling that are used are variable.

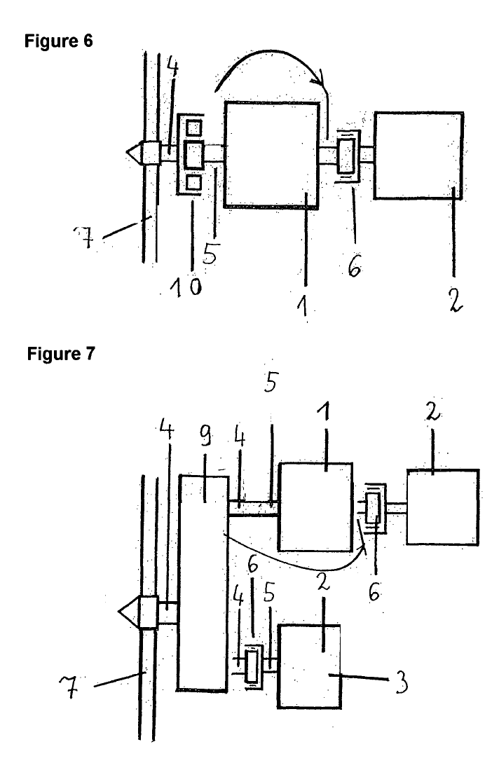

FIG. 6 shows a multistage wind-powered generator in which an epicyclic transmission 10 is arranged between the wind-powered rotor 7 and the first generator stage 1. The epicyclic transmission 10 may be arranged upstream of the first stage of the multistage generator, or between the generator stages.

FIG. 7 shows a wind-powered rotor with a multistage generator. A transmission is arranged between the wind-powered rotor 7 and the first generator stage 1. However, the transmission 9 may also drive further generator stages in the multistage generator (generator stage 2 or 3), which can be connected to the transmission 9, or can be disconnected from the transmission 9, by way of a coupling 6.

### LIST OF REFERENCE SYMBOLS

1. Main generator, main electricity generator
2. Second generator
3. Third generator
4. Main drive shaft
5. Shaft for the generator stages which are arranged one behind the other or alongside one another
6. Couplings
7. Wind-powered rotor
8. Wind-powered rotor blades or other objects which are rotated by the wind
9. Transmission
10. Epicyclic transmission

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A multistage wind-powered generator, comprising:
at least one main shaft; and
at least two generators, each coupled to the at least one shaft and arranged at least one of one behind the other and side by side, coupled to a mechanical device adapted to use wind power.

2. The multistage wind-powered generator as claimed in claim 1, wherein different generator stages are at least one of connectable and disconnectable at different wind speeds.

3. The multistage wind-powered generator as claimed in claim 1, wherein a sequence for connection and an opposite sequence for disconnection remain the same irrespective of the configuration of the multistage wind-powered generator and the number of generator stages.

4. The multistage wind-powered generator as claimed in claim 1, wherein individual generator stages are connected by differing types of shafts and coupling systems, including a remotely controlled coupling system.

5. The multistage wind-powered generator as claimed in claim 1, wherein the multistage wind-powered generator is used with at least one of any system which uses wind power and with any type of wind-powered rotor.

6. The multistage wind-powered generator as claimed in claim 1, wherein the generators are held by at least one of at least one special holder and by at least one continuous shaft.

7. The multistage wind-powered generator as claimed in claim 1, wherein an epicyclic transmission is arranged between at least one of the wind-powered device and a first generator stage of the multistage generator, and between the stages of the multistage generator.

8. The multistage wind-powered generator as claimed in claim 1, wherein, in the case of a wind-powered rotor with a multistage generator, the transmission drives at least two generator stages, in which case the generator stages are at least one of connectable and disconnectable to the transmission by at least one coupling.

9. The multistage wind-powered generator as claimed in claim 2, wherein a sequence for connection and an opposite sequence for disconnection remain the same irrespective of the configuration of the multistage wind-powered generator and the number of generator stages.

10. The multistage wind-powered generator as claimed in claim 4, wherein, in the case of lateral power transmission, all the mechanical power transmission types are usable and wherein, for some types, the mechanical device which uses wind power is arranged between the generator stages.

11. The multistage wind-powered generator as claimed in claim 1, wherein at least one of the generators is directly coupled to the at least one main shaft.

12. The multistage wind-powered generator as claimed in claim 1, wherein at least one of the generators is coupled to the at least one main shaft via a coupling system.

13. The multistage wind-powered generator as claimed in claim 11, wherein at least one of the generators is coupled to the at least one main shaft via a coupling system.

14. The multistage wind-powered generator as claimed in claim 11, wherein different generator stages are at least one of connectable and disconnectable at different wind speeds.

15. The multistage wind-powered generator as claimed in claim 12, wherein different generator stages are at least one of connectable and disconnectable at different wind speeds.

16. The multistage wind-powered generator as claimed in claim 13, wherein different generator stages are at least one of connectable and disconnectable at different wind speeds.

17. A multistage wind-powered generator, comprising:
at least one main shaft; and
at least two generator stages, each including at least one generator, each generator stage coupled to the at least one shaft, wherein the at least two generator stages are arranged at least one of one behind the other and side by side, and are coupled to a mechanical device adapted to use wind power.

18. The multistage wind-powered generator as claimed in claim 17, wherein at least one of the generators is coupled to the at least one main shaft via a coupling system.

19. The multistage wind-powered generator as claimed in claim 17, wherein different generator stages are at least one of connectable and disconnectable at different wind speeds.

20. The multistage wind-powered generator as claimed in claim 18, wherein different generator stages are at least one of connectable and disconnectable at different wind speeds.

21. The multistage wind-powered generator as claimed in claim 17, wherein a sequence for connection and an opposite sequence for disconnection remain the same irrespective of the configuration of the multistage wind-powered generator and the number of generator stages.

22. The multistage wind-powered generator as claimed in claim 17, wherein individual generator stages are connected by differing types of shafts and coupling systems, including a remotely controlled coupling system.

23. The multistage wind-powered generator as claimed in claim 1, wherein an epicyclic transmission is arranged between at least one of the wind-powered device and a first generator stage of the multistage generator, and between the stages of the multistage generator.

24. The multistage wind-powered generator as claimed in claim 1, wherein, in the case of a wind-powered rotor with a multistage generator, the transmission drives at least two generator stages, in which case the generator stages are at least one of connectable and disconnectable to the transmission by at least one coupling.
